(19) United States
(12) Patent Application Publication
(10) Pub. No.: US 2026/0058117 A1
(43) Pub. Date: Feb. 26, 2026

(54) SYSTEM AND METHOD OF MANUFACTURING ELECTRODES USING GRADIENT ROLLER SIZES

(71) Applicant: GM Global Technology Operations LLC, Detroit, MI (US)

(72) Inventors: Meiyuan Wu, Pudong (CN); Yong Lu, Shanghai (CN); Haijing Liu, Shanghai (CN)

(21) Appl. No.: 18/822,995

(22) Filed: Sep. 3, 2024

(30) Foreign Application Priority Data
Aug. 21, 2024 (CN) 202411156443.X

(51) Int. Cl. H01M 4/04; H01M 4/02; H01M 4/1391; H01M 4/525; H01M 4/62

(52) U.S. Cl. CPC H01M 4/0435; H01M 4/1391; H01M 4/525; H01M 4/623; H01M 4/625; H01M 2004/021; H01M 2004/028

(57) ABSTRACT

A system and method for manufacturing an electrode sheet. The system includes groups of rollers having increasing diameter gradient to calendar an active material film having an initial thickness to a predetermined production thickness. The initial thickness is continually reduced as the active material film is calendared through the group of rollers. The groups of rollers includes a first group of rollers and a second group of rollers disposed immediately downstream of the first group of rollers. The first group of rollers includes a first roller radius and the second group of rollers includes a second roller radius greater than the first roller radius. The first group of rollers includes a first gap between adjacent rollers and the second group of rollers includes a second gap between adjacent rollers, in which the second gap is equal to or less than the first gap.

### INTRODUCTION

The present disclosure relates to a method of making a battery cell, and more particularly to a method of making electrodes for a battery cell using increasing roller size gradient.

Rechargeable lithium-on batteries have the ability to hold a relatively high energy density, a relatively low internal resistance, and a low self-discharge rate when not in use as compared to older types of rechargeable batteries such as nickel metal hydride, nickel cadmium, or lead acid batteries. Electric and hybrid vehicles predominantly use rechargeable lithium ion batteries as a dependable power source due to the lithium ion batteries'ability to undergo repeated power cycling over their useful lifetimes.

A rechargeable lithium ion battery cell typically include a positive electrode, a negative electrode, an electrolyte, and a separator layer disposed between the positive and negative electrodes. The positive electrode is referred to as a cathode electrode and includes a cathode active material layer arranged on a cathode current collector. The negative electrode is referred to as an anode electrode and includes an anode active material layer arranged on an anode current collector.

Electrodes may be manufactured by a solvent-free electrode fabrication process, also referred to as a dry process, which is beneficial over a process that requires the use of solvents. Besides the elimination of solvents, the dry process eliminates the need for drying equipment and drying time, thus reducing the footprint and cost of manufacturing electrodes. In the dry process, one or more pairs of calendaring rollers compresses a dry mixture of active materials, binders, and other materials to form an active electrode layer to a desired thickness, and then laminates the compressed active electrode layer on the current collector. The dry process is suitable for preparing active material layers having a thickness of greater than 100 micrometer (μm). However, certain electrodes requires lower active material layer thicknesses for improved performance and/or packaging considerations.

Thus, while conventional methods of solvent-free electrode fabrication process achieve their intended purpose, there is a need for a more effective method for making electrodes having an active material layer thickness lower than 100 μm.

### SUMMARY

According to several aspects, a system for manufacturing an electrode sheet is provided. The system includes a plurality of groups of rollers configured to calendar an active material film having an initial thickness. The initial thickness is continually reduced as the active material film is calendared through the plurality of groups of rollers. The plurality of groups of rollers includes a first group of rollers and a second group of rollers disposed immediately downstream of the first group of rollers. The first group of rollers includes a first roller radius and the second group of rollers includes a second roller radius greater than the first roller radius.

In an additional aspect of the present disclosure, the plurality of groups of rollers further includes an N group of rollers, wherein N is an integer greater than 2. The N group of rollers include an N roller radius greater than a roller radius of any group of rollers preceding the N group of rollers.

In another aspect of the present disclosure, the first group of rollers is a first pair of rollers including a first-pair first roller and a first-pair second roller spaced from the first-pair first roller defining a first pair gap (G1) therebetween. The second group of rollers is a second pair of rollers including a second-pair first roller and a second-pair second roller spaced from the second-pair first roller defining a second pair gap (G2) therebetween, wherein G2 is equal to or less than G1.

In another aspect of the present disclosure, the first group of rollers includes a first pair of rollers having a first-pair first roller and the first-pair second roller. The second group of rollers comprises a second pair of rollers having a second-pair first roller and a second-pair second roller. Each of the first-pair first roller and the first-pair second roller includes a first group roller radius (R1). Each of the second-pair first roller and the second-pair second roller includes a second group roller radius (R2), wherein R2 is greater than R1.

In another aspect of the present disclosure, the plurality of groups of rollers further includes an N group of rollers, wherein N is an integer greater than 2. The N group of rollers include an N roller radius (RN) greater than R2.

In another aspect of the present disclosure, the first group of rollers includes at least 2 first-group rollers having a first group roller radius of R1. The second group of rollers includes at least 2 second-group rollers having a second-group roller radius of R2, wherein R2 is greater than R1.

In another aspect of the present disclosure, the first group of rollers includes a first-group end roller. The second group of rollers includes a second-group front roller. The second-group front roller is disposed immediately adjacent to the first-group end roller defining a group gap (GA) therebetween.

In another aspect of the present disclosure, the first-pair first roller rotatable at a different speed with respect to the first-pair second roller.

In another aspect of the present disclosure, at least one of the plurality of groups of rollers is heatable to a temperature of 80° C. to 200° C.

In another aspect of the present disclosure, the active material film includes a binder comprising a polytetrafluoroethylene (PTFE).

According to several aspects, a method of manufacturing a cathode sheet is provided. The method includes calendaring an active material film through a sequential groups of rollers. Each subsequent group of rollers has a larger diameter than the proceeding groups of rollers, to reduce the thickness of the active material film to less than 80 microns. The raw active material film includes greater than 80 weight percent nickel (Ni), and a binder comprising polytetrafluoroethylene (PTFE). The active material film includes LiNi_{0.8}Co_{0.1} Mn_{0.1}O₂ (NCM811):Super P carbon(SP):PTFE in a 95:3:2 ratio by weight.

In an additional aspect of the present disclosure, the groups of rollers are pairs of rollers having a same size radius. One of the rollers in a pair of rollers is rotated at a different speed with respect to the other roller in the pair of rollers.

In another aspect of the present disclosure, the plurality of groups of rollers includes a first group of rollers and a second group of rollers disposed immediately downstream of the first group of rollers. The first group of rollers includes a first roller radius and the second group of rollers includes a second roller radius greater than the first roller radius.

According to several aspects, a method of manufacturing a cathode sheet is provided. The method includes calendaring an active material film having an initial thickness through a plurality of groups of rollers to reduce the initial thickness to a predetermined production thickness, and laminating the calendared active material film onto a current collector. The plurality of groups of rollers are arranged in a calendaring sequence based on a group roller radius from small to large.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic representation of a cross-section of a rechargeable battery, according to an exemplary embodiment;

FIG. 2 is a schematic diagram of a system for manufacturing electrodes using increasing roller size gradient, according to an exemplary embodiment;

FIG. 3 is a schematic diagram of a system for manufacturing electrodes using increasing roller size gradient, according to another exemplary embodiment; and

FIG. 4 is a block diagram of a method of manufacturing electrodes using increasing roller size gradient, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers, and/or sections. These elements, components, regions, layers, and/or sections should not be limited by these terms. These terms may be only used to distinguish one element, component, region, layer or section from another region, layer, or section. Terms such as “first,” “second,” and other numerical terms do not imply a sequence or order unless clearly indicated by the context. Thus, a first element, component, region, layer, or section discussed below could be termed a second element, component, region, layer, or section without departing from the teachings of the example configurations.

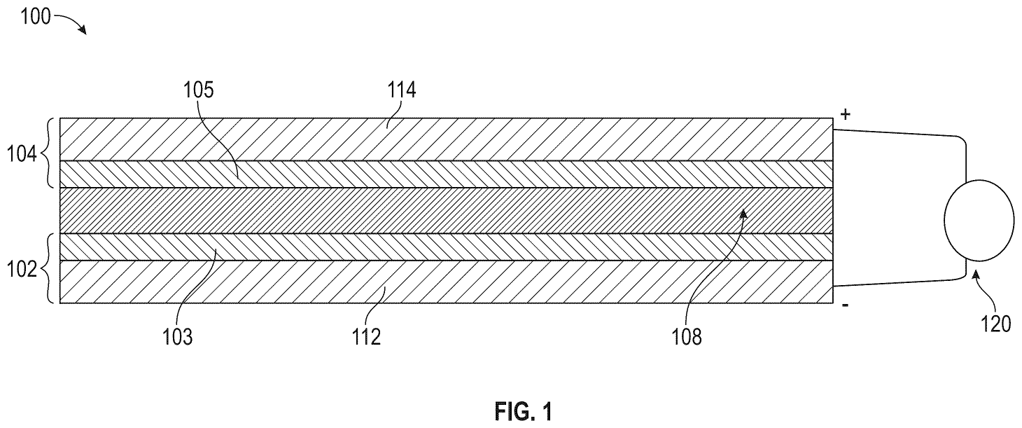

FIG. 1 is a diagrammatic representation of a rechargeable battery, such as a rechargeable lithium-ion battery, generally indicated by reference number 100, also referred to as battery 100. The battery 100 includes a negative electrode 102, a positive electrode 104, and a separator layer 108 disposed between the negative electrode 102 and positive electrode 104. The separator layer 108 includes an electrolyte material suitable for conducting lithium ions between the negative electrode 102 and the positive electrode 104. The negative electrode 102 includes a lithium accepting active material 103 and the positive electrode 104 includes a lithium-based active material 105 that can store lithium ions at a higher electric potential than the lithium accepting host material 103 of the negative electrode 102. A binder comprising polytetrafluoroethylene (PTFE) is incorporated with the lithium accepting active material 103 and the lithium-based active material 105.

The positive electrode 104 is also referred to as a cathode 104 due to its higher electrochemical potential and the negative electrode 102 is also referred to as an anode 102 due to its relative lower electrochemical potential. Each of the lithium accepting active material 103 of the anode and lithium-based active material 105 of the cathode is laminated on to a respective current collector 112, 114. The current collectors 112, 114 may be formed from electrically conductive metals such as copper for the negative electrode 102 and aluminum for the positive electrode 104.

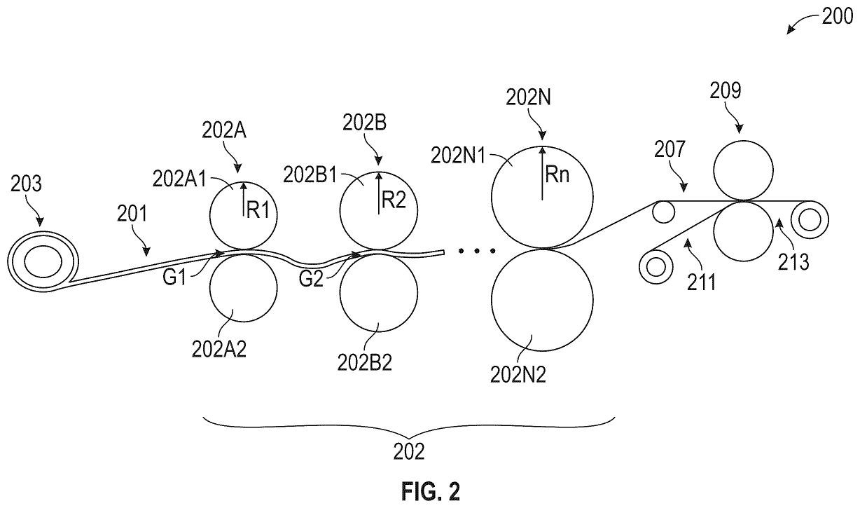

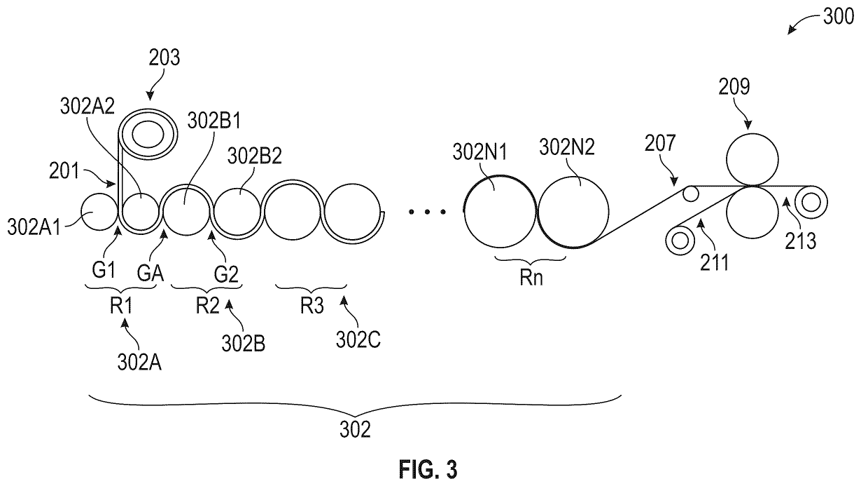

FIG. 2 and FIG. 3 are schematic diagrams of alternative embodiments of systems 200, 300, respectively, for manufacturing electrodes using sequential groups of rollers having increasing roller size gradient. The alternative embodiments of the systems 200, 300 are configured to calendar a raw active material film 201 through a sequence of grouped rollers and laminate the calendared active material film, also referred to as a calendared active material layer, onto a current collector to form an electrode sheet. The systems are operated to output the electrode sheet 213 in a steady state predetermined production line speed, also referred to as line speed, which may be measured in production units produced per minute. The line speed for producing an electrode sheet may be expressed as a linear length of electrode sheet produced per unit time, such feet per minute (ft/min).

A non-limiting example of a composition of the raw active material film includes an active material, a binder composed of polytetrafluoroethylene (PTFE), and optionally, one or more conductive additives such as conductive carbon and/or conductive polymers. The active material depends on whether the end manufactured electrode sheet is a cathode sheet or an anode sheet. In a non-limiting example for manufacturing a cathode electrode sheet, the active material include a cathode active material such as LiNi_{0.8}Co_{0.1} Mn_{0.1}O₂ (NCM811):Super P carbon(SP):PTFE in a 95:3:2 ratio by weight. In a non-limiting example for manufacturing an anode electrode sheet, the active material include an anode active material such as graphite (Gr):SP:PTFE=97:1:2 ratio by weight.

The raw active material film 201 may be manufactured by first preparing a dry mixture of the active material, PTFE binder, and optionally, conductive additive. The dry mixture is also referred to as electrode powder mixture. The electrode powder mixture undergoes shear fibrillation and subjected to a pre-calendaring process to form the raw active material film 201. The pre-calendaring process may include compressing the electrode powder mixture material through a number of pairs of heated rollers to form a single continuous sheet of raw active material film 201. The raw active material film 201 may be wrapped into a roll 203 for use in the systems 200, 300 as shown in FIG. 2 and FIG. 3.

Referring to FIG. 2, the system 200 includes a film roll dispenser 203, sequential pairs of rollers 202 having increasing roller diameters (radiuses), and a laminating unit 209. The film roll dispenser 203 is configured to retain the roll of raw active material film 201 and to feed the raw active material film 201 to the sequential pairs of rollers 202 for calendaring to reduce the thickness of the raw active material film 201 as it progresses through the sequential pairs of rollers 202.

In the embodiment shown, the System 200 includes a plurality of pairs of rollers 202A-202N disposed in series in a calendaring process to reduce the thickness of a raw active material film 201. In general, subsequent pairs of rollers in the progression of the calendaring process have larger diameters, expressed as radiuses R1, R2, RN, than the pairs of rollers proceeding it. However, immediate adjacent pairs of rollers may have the same roller diameters to improve the quality of the calendared active material film. For a particular pair of rollers, the radiuses of the rollers are the same, however, the rotational speeds of the rollers may differ.

The system 200 includes at least a first pair of rollers 202A, a second pair of rollers 202B, and up to an N pair of rollers 202N, where N is an integer greater than 2. The raw active material film 201 is fed to the first pair of rollers 202A, followed by the second pair of rollers 202B, and if so equipped, through the N pair of rollers 202N. After calendaring, the calendared active material layer 207 is fed to the laminating unit 209 to laminate the calendared active material layer 207 with the current collector 211 to form an electrode sheet 213. The electrode sheet 213 is shown collected onto roll.

The first pair of rollers 202A includes a first-pair first roller 202A1, a first-pair second roller 202A2. The first-pair first roller 202A1 is spaced from the first-pair second roller 202A2 to define a first-pair roller gap (G1) therebetween. Each of the first-pair first roller 202A1 and the first-pair second roller 202A2 includes a radius of R1. The second pair of rollers 202B includes a second-pair first roller 202A1 and a second-pair second roller 202B2. The second-pair first roller 202A1 is spaced from the second-pair second roller 202B2 to define a second-pair gap (G2) therebetween. Each of the second-pair first roller 202A1 and the second-pair second roller 202B2 includes a radius of R2. The N pair of rollers 202N includes an N-pair first roller 202N1 and an N-pair second roller 202N2. The N-pair first roller 202N1 is spaced from the N-pair second roller 202N2 to define a N-pair gap (GN) therebetween. Each of the N-pair first roller 202N1 and the N-pair second roller 202N2 includes a radius of RN.

The radius of the N-pair rollers (RN) is greater than the radius of the second-pair rollers (R2), which is greater than the first-pair rollers (R1) (RN>R2>R1). The N-pair gap (GN) is equal to or less than the second-pair gap (G2), which is equal to or less than the first pair gap (G1) (GN=<G2=<G1). The initial smaller diameter pairs of rollers 202A are beneficial to the PTFE fibrils formation and gradually decrease thickness of the active material film while avoiding early-stage over densification. Subsequent pairs of rollers along the calendaring process has a larger diameter (i.e. radius) than the preceding pairs of rollers. On occasions, immediate adjacent pairs of rollers may have the same roller diameters before transitioning to the next pair of rollers having larger diameter sizes to produce high quality calendared active material layers 207.

The rollers in each pair of rollers may be individually driven by a single motor and/or each pair of rollers may be driven by a single motor. The speed or revolution per minute (RPM) of each pair of rollers are controlled to output the desired production line rate. The second pair of rollers 202B may be rotated at a lower RPM as compared to the first pair of rollers 202A to achieve the predetermined line speed because the circumference of the secondary pair of rollers 202B is greater than the first pair of roller 202A. With respect to each pair of rollers, the first roller and the second roller forming a pair of rollers may have a rotational speed ratio of 1.0 to 2.0 difference with respect to each other. All the rollers can be heated to the upper limit temperature of 80° C. to 200° C.

FIG. 3 is a schematic diagram of another embodiment of a system for manufacturing electrodes using a plurality of groups of increasing gradient roller sizes (System 300). The system 300 includes a film roll dispenser 203, a plurality of groups of rollers 302 in series, and a laminating unit 209. Each group of rollers 302A, 302B, 302C, 302N includes two or more rollers (i.e. 302A1, 302A2 with respect to group of roller 302A) having the same diameter rollers. Each subsequent groups of rollers includes a larger diameter size rollers than the immediately preceding group of rollers in the calendaring process. A raw active material film 201 is fed to the first group of rollers 302A, through a second group of rollers 302B, a third group of rollers 302C, and if so equipped, through an N group of rollers 302N. The last roller in a group of rollers cooperates with the first roller in an immediate subsequent group of rollers in calendaring of the raw active material film (i.e. roller 302A1 cooperates with 302B1) and transition the active material film 201 from one group of rollers to the next group of rollers. After calendaring, the calendared active material layer 207 is fed to the laminating unit 209 to laminate the calendared active material layer 207 with the current collector 211 to form an electrode sheet 213. The electrode sheet 213 is then collected onto roll.

The plurality of groups of rollers 302 includes at least a first group of rollers 302A, a second group of rollers 302B, and optionally up to an N group of rollers 302N, where N is an integer greater than 2. The first group of rollers 302A includes a plurality of first group rollers 302A1, 302A2 having a same first roller radius (R1). The second group of rollers 302B includes a plurality of second group rollers 302B1, 302B2 having a same second roller radius (R2). The N group of rollers 302N includes a plurality of N group rollers 302N1, 302N2 having a same N roller radius (RN). The N roller radius (RN) is greater than the second roller radius (R2), which is greater than the first roller radius (R1) (RN>R2>R1).

In the embodiment shown, the first group of rollers 302 include a first-group first roller 302A1 and a first-group last roller 302A2. In one embodiment, there may be a plurality of first group rollers between the first-group first roller 302A1 and the first-group last roller 302A2. The second group of rollers 302B includes a second-group first roller 302B1 and a second-group last roller 302B2. The first-group last roller 302A2 is immediate adjacent to and cooperates with the second-group first roller 302B1 to calendar the raw material film 201 while the raw material film 201 is transitioning from the first group of rollers 302A to the larger diameter second group of rollers 302B. The process continues where the last roller of one group cooperates with the larger diameter first roller of the immediate subsequent group to calendar the raw material film. On occasions, immediate adjacent groups of rollers may have the same roller diameters before transitioning to the next group of rollers having larger diameter sizes to produce high calendared active material layers 207.

The first-group first roller 302A1 is spaced from the first-group second roller 302A2 to define a first group roller gap (G1) therebetween. The second-group first roller 302B1 is disposed adjacent the first-group second roller 302A2 defining a gap A (GA) therebetween. The second-group first roller 302B1 is spaced from the second-group second roller 302B2 to define a second group gap (G2) therebetween. The second-group roller gap (G2) is equal to or less than the first-group roller gap (G1) (G2=>G1).

In Systems 200, 300 when the active material film is fed between two immediate adjacent rollers, the active material film is mainly exposed to shearing forces in a feed zone and compression forces in a nip zone. The larger radius rollers dominates a higher compaction force on the active material film thus making the film denser into a compressed active material layer. However, higher compact forces result in the film hard to flow and shear through the gap between the two rollers to form electrodes. By having smaller radius rollers in the initial stages of the calendaring process, enables a lower compaction force, thus providing a “soft” press, which is beneficial to decreasing the thickness of film. By providing rollers having a gradient increase in roller radius as the film progresses through the calendaring process provides a balance between shearing and compacting requirements.

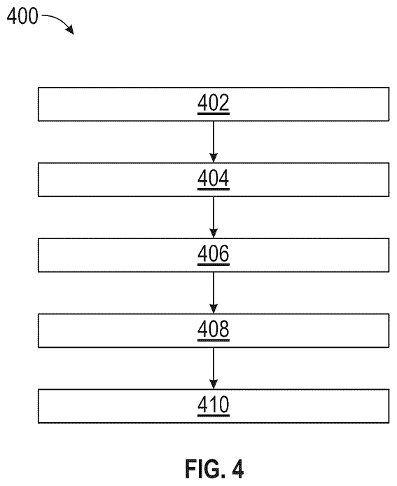

FIG. 4 is a block diagram of a method 400 of manufacturing electrodes using increasing gradient roller sizes, according to an exemplary embodiment. At Block 402, preparing a dry powder mixture of the active material, PTFE binder, and optionally, conductive additive. The active material may be that of an anode active material or that of a cathode active material. In the case of the cathode active material, the cathode active material includes lithium nickel cobalt aluminum oxide (NCMA) having greater than 80 weight percent (wt %) of Nickel.

At Block 404, subjecting the dry powder mixture to high-shear force fibrillation. Non-limiting examples include processing the dry powder mixture through twin screw extruder and/or jet milling machines to form a uniform mixture of electrode power mixture material.

At block 406, pre-calendaring by compressing the electrode powder mixture material through a number of pairs of heated rollers to form a single continuous sheet of raw active material film having a thickness of 80 μm or less.

At Block 408, calendaring the raw active material film through sequential groups of rollers, wherein each subsequent group of rollers has a larger diameter than the proceeding groups of rollers, to reduce the thickness of the raw active material film. In certain embodiments, there may be two or more immediately adjacent groups of rollers having the same radius.

At Block 410, laminating the calendared reduced thickness active material layer, electrode layer, onto a current collector to form an electrode sheet.

The above method 400 executed in Systems 200 and 300 enables the manufacturing of a high nickel cathode, typically having a nickel content higher than 80%, to have a thickness of less than 80 μm. An example of such a high nickel cathode includes lithium nickel cobalt aluminum oxide (NCMA) cathodes, which includes a thickness of 75 μm or less to deliver a capacity loading of 5.0 mAh/cm².

Numerical data have been presented herein in a range format. “The term “about” as used herein is known by those skilled in the art. Alternatively, the term “about” includes +/−0.5%” of stated value. It is to be understood that this range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. While examples have been described in detail, those familiar with the art to which this disclosure relates will recognize various alternative designs and examples for practicing the disclosed method within the scope of the appended claims.

The description of the present disclosure is merely exemplary in nature and variations that do not depart from the general of the present disclosure are intended to be within the scope of the present disclosure. Such variations are not to be regarded as a departure from the spirit and scope of the present disclosure.

What is claimed is:

1. A system for manufacturing an electrode sheet, comprising:
a plurality of groups of rollers configured to calendar an active material film having an initial thickness, wherein the initial thickness is reduced as the active material film is calendared through the plurality of groups of rollers;
wherein the plurality of groups of rollers includes a first group of rollers and a second group of rollers disposed immediately downstream of the first group of rollers; and
wherein the first group of rollers includes a first roller radius and the second group of rollers includes a second roller radius greater than the first roller radius.

2. The system of claim 1, wherein the plurality of groups of rollers further includes an N group of rollers, wherein N is an integer greater than 2; and
wherein the N group of rollers include an N roller radius greater than a roller radius of any group of rollers preceding the N group of rollers.

3. The system of claim 1, wherein:
the first group of rollers is a first pair of rollers comprising a first-pair first roller and a first-pair second roller spaced from the first-pair first roller defining a first pair gap (G1) therebetween; and
the second group of rollers is a second pair of rollers comprising a second-pair first roller and a second-pair second roller spaced from the second-pair first roller defining a second pair gap (G2) therebetween, wherein G2 is equal to or less than G1.

4. The system of claim 1, wherein:
the first group of rollers comprises a first pair of rollers having a first-pair first roller and a first-pair second roller;
the second group of rollers comprises a second pair of rollers having a second-pair first roller and a second-pair second roller;
each of the first-pair first roller and the first-pair second roller includes a first group roller radius (R1); and
each of the second-pair first roller and the second-pair second roller includes a second group roller radius (R2), wherein R2 is greater than R1.

5. The system of claim 4, wherein the plurality of groups of rollers further includes an N group of rollers, wherein N is an integer greater than 2; and
wherein the N group of rollers include an N roller radius (RN) greater than R2.

6. The system of claim 1, wherein:
the first group of rollers comprises at least 2 first-group rollers having a first group roller radius of R1; and
the second group of rollers comprises at least 2 second-group rollers having a second-group roller radius of R2, wherein R2 is greater than R1.

7. The system of claim 6, wherein:
the first group of rollers includes a first-group end roller; and
the second group of rollers includes a second-group front roller; and
wherein the second-group front roller is disposed immediately adjacent to the first-group end roller defining a group gap (GA) therebetween for calendaring the active material film.

8. The system of claim 3, wherein:
the first-pair first roller is rotatable at a different speed with respect to the first-pair second roller.

9. The system of claim 1, wherein at least one of the plurality of groups of rollers is heatable to a temperature of 80° C. to 200° C.

10. The system of claim 1, wherein the active material film includes a binder comprising a polytetrafluoroethylene (PTFE).

11. A method of manufacturing a cathode sheet, comprising:
calendaring an active material film through a sequential groups of rollers, wherein each subsequent group of rollers has a larger diameter than proceeding groups of rollers, to reduce a thickness of the active material film to less than 80 microns; and
wherein the active material film comprises:
greater than 80 weight percent nickel (Ni), and
a binder comprising polytetrafluoroethylene (PTFE).

12. The method of claim 11, wherein at least one of the sequential groups of rollers is a pair of rollers having a same size radius; and
wherein one of the rollers in the pair of rollers is rotatable at a different speed with respect to the other roller in the pair of rollers.

13. The method of claim 12, wherein the pair of rollers are heated to a temperature of 80° to 200° C.

14. The method of claim 11, wherein the active material film comprises LiNi_{0.8}Co_{0.1} Mn_{0.1}O₂ (NCM811):Super P carbon(SP):PTFE in a 95:3:2 ratio by weight.

15. The method of claim 11, wherein the sequential groups of rollers includes a first group of rollers and a second group of rollers disposed immediately downstream of the first group of rollers; and
wherein the first group of rollers includes a first roller radius and the second group of rollers includes a second roller radius greater than the first roller radius.

16. A method of manufacturing an electrode sheet, comprising:
calendaring an active material film having an initial thickness through a plurality of groups of rollers to reduce the initial thickness to a predetermined production thickness; and
laminating the calendared active material film onto a current collector; and
wherein the plurality of groups of rollers are arranged in a calendaring sequence based on a group roller radius gradient from a smaller radius to a larger radius.

17. The method of claim 16, wherein at least one of the plurality of groups of rollers comprises a pair of rollers.

18. The method of claim 16, further comprising heating the groups of rollers to a temperature of 80° C. to 200° C.

19. The method of claim 16, wherein the active material film comprises a polytetrafluoroethylene (PTFE).

20. The method of claim 19,
wherein the active material film comprises greater than 80 weight percent nickel (NI); and
wherein the predetermined production thickness is less than less than 80 μm.
